(19) United States
(12) Patent Application Publication
(10) Pub. No.: US 2011/0167496 A1
(43) Pub. Date: Jul. 7, 2011

(54) ENHANCED HARDWARE COMMAND FILTER MATRIX INTEGRATED CIRCUIT

(75) Inventors: Lon Daniel McPhail, San Diego, CA (US); David S. Gillett, San Diego, CA (US)

(73) Assignee: KUITY CORP., San Diego, CA (US)

(21) Appl. No.: 13/045,492

(22) Filed: Mar. 10, 2011

Related U.S. Application Data
(63) Continuation-in-part of application No. 12/831,974, filed on Jul. 7, 2010.
(60) Provisional application No. 61/223,647, filed on Jul. 7, 2009.
(60) Provisional application No. 61/254,567, filed on Oct. 23, 2009.

(51) Int. Cl. G06F 21/00

(52) U.S. Cl. 726/24; 726/26

(57) ABSTRACT

A semiconductor integrated circuit includes a hardware mechanism arranged to ensure that associations between instructions and data are enforced so that a processor cannot execute an instruction that is not authorized. A Command Filter Matrix stores entries comprising instructions and associated data memory ranges. A hardware arrangement denies command execution if the CPU attempts to make a data fetch from an instruction that is outside the range associated with data in the Command Filter Matrix. The Command Filter Matrix may be implemented in a Field Programmable Gate Array such that the memory cell content is pre-programmed with entrusted code by a separate trusted hardware source. In this way, an operating system may function normally but only execute trusted instructions, commands and memory operations. The Command Filter Matrix also contains external write-only capability to enable external monitoring of performance.

### CROSS-REFERENCE TO RELATED APPLICATIONS

The present application is a continuation-in-part of copending U.S. patent application Ser. No. 12/831,974 which was filed Jul. 7, 2010 and which claimed priority from U.S. Provisional Patent Application No. 61/223,647, filed Jul. 7, 2009, and from U.S. Provisional Patent Application No. 61/254,567, filed Oct. 23, 2009, all of which applications are expressly incorporated by reference herein for all purposes.

### BACKGROUND OF THE INVENTION

1. Field of the Invention

The present invention relates generally to integrated circuits and more particularly to controlling the code that can be executed on microprocessors using a combination of hardware and software command filters.

2. Description of Related Art

Related art is drawn from two fields: software that implements or controls data flow into or out of a microprocessor-driven system under security protocols or policies and hardware implemented as network firewall protection.

### BRIEF SUMMARY OF THE INVENTION

Certain embodiments of the present invention comprise systems and methods applicable to integrated circuits including microprocessors, including microprocessors used in personal computers, workstations, servers, networking devices, telecommunications devices, encryption hardware, mechanized vehicles of all types, and any device with the capability of storing, transporting, or processing of data and data control system applications. According to certain aspects of the invention, a processor may not run unauthorized and/or undesired code that could impair or compromise either the integrity of the data or function of the system.

### BRIEF DESCRIPTION OF THE DRAWINGS

FIG. 1 is a block diagram illustrating a command filter matrix according to certain aspects of the invention.

FIG. 2 depicts a signal transport filter mechanism according to certain aspects of the invention.

FIG. 3 is a simplified drawing depicting one example of an embodiment according to certain aspects of the invention.

FIG. 4A is a simplified cross-sectional view showing the location of a CFM in a socket used to mount an integrated circuit to a printed wiring board.

FIG. 4B is a simplified cross-sectional view showing a CFM that mounts an integrated circuit to a printed wiring board.

FIG. 4C is a simplified cross-sectional view of a CFM embedded in a printed circuit board.

FIG. 5 is a flowchart illustrating the operation of a command filter according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

For the purposes of this description, a command filter matrix (“CFM”) is understood to mean a proprietary hardware device that the CFM may be embodied in a memory cell matrix encoded and configured by a trusted source. However, it is contemplated that a CFM may be embodied in other types of device as indicated by specific use and application of the invention. For the purposes of this description, malicious hardware is understood to mean a functionality that is embedded in external (to the microprocessor) peripheral devices, integrated circuits or memory devices and considered potentially harmful. For the purposes of this description, hardware exploitation malware (“malware”) is understood to mean software components, such as computer viruses, which are designed to exploit unauthorized run-time capabilities of an electronic data processing environment.

Certain embodiments of the present invention comprise systems and methods applicable to integrated circuits including microprocessors, microprocessors used in personal computers, workstations, servers, networking devices, telecommunications devices, encryption hardware, mechanized vehicles of all types, and any device with the capability of storing, transporting, or processing of data and data control system applications. Aspects of the present invention can protect various other devices capable of processing instructions, including controllers (and microcontrollers), sequencers, numerical controlled devices, dynamically configurable processors, digital signal processors, graphic processing devices, hard disk drive and other storage media controllers, keyboard, mouse and other user interface controllers. Processors, controllers and sequencers may be embedded in devices used in chipsets, peripheral component interconnects, serial bus controllers and devices connected using serial buses. Certain embodiments of the invention may be deployed to detect and avert threats posed by malware affecting storage devices, including mass storage devices and ROMs, PROMs, EPROMs, EEPROMs and flash memory used to maintain instructions, arguments and parameters that control processing in a device. For example, a CFM can be used to monitor accesses of the basic input/output system (“BIOS”) and other firmware used in a computing device.

CFM devices may be used in computers, mobile computing devices, tablet computers, cellular telephones, smartphones, media players, gaming devices, communications switches, hubs and gateways, modems, radio frequency transmitters, receivers and transceivers, navigation devices and any other device that can be programmed.

According to certain aspects of the invention, a command filter matrix comprises a trusted-source filtering element that prevents a processor from running unauthorized and/or undesired code that could impair or compromise either the integrity of the data or function of the system.

Certain embodiments of the invention provide systems, methods, processes, circuits and tools to assure that only trusted commands and instructions are executed by a microprocessor. According to certain aspects of the invention, a universal solution may be employed to assure that malicious hardware content, present in unknown hardware and software system resources, is prevented from entering, controlling or compromising any system under control of the microprocessor or related integrated circuit.

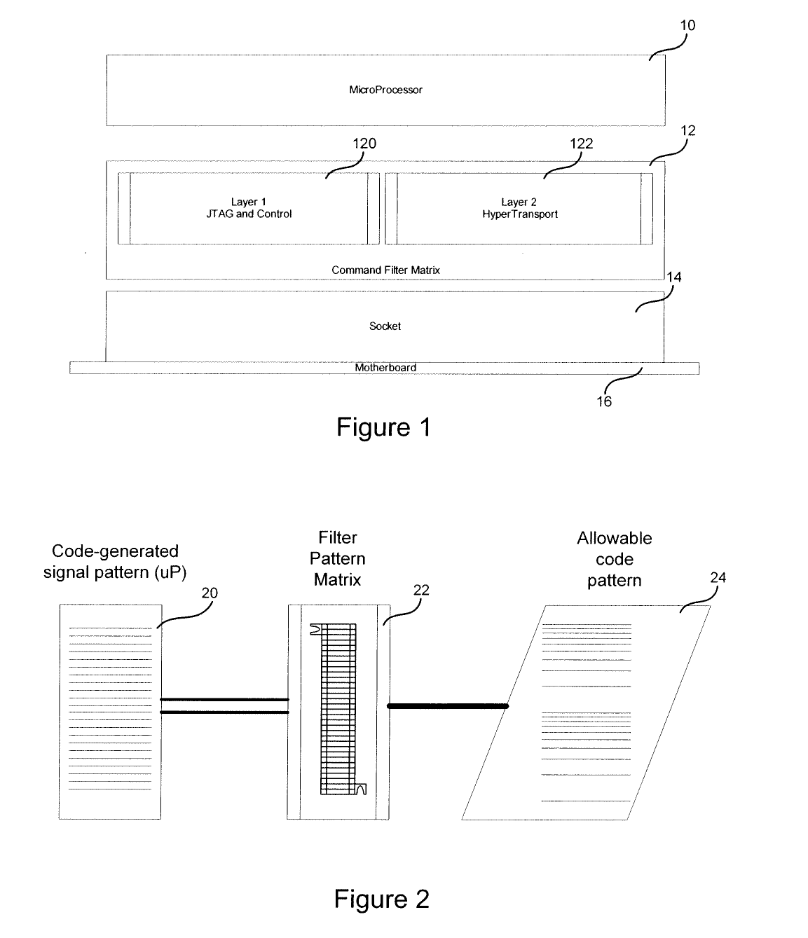

With reference to FIG. 1, certain embodiments provide a proprietary in-line hardware device 12 that creates a trusted-source filter for microprocessor 10 or integrated circuit code execution. Trusted source filter 12 may comprise layered control elements, including, for example, a layer 1 JTAG and control element 120 and a layer 2 hyper transport element 122. In one example, trusted source filter 12 is inserted between microprocessor 10 and a socket 14 provided on motherboard 16. In another example, a lightweight, lower profiled embodiment is achieved by embedding the command filter matrix within the Socket itself, thus eliminating elevation growth.

Referring also to FIG. 2, a two-layer detection and protection scheme can be implemented on an integrated circuit, which is designated herein as the command filter matrix chip (CFM) 12. The CFM 12 is typically embedded into a hardware construct wherein the signal input is a microprocessor and the signal output is engaged into the normal socket 14 or direct interconnect to motherboard 16 where the microprocessor 10 is normally inserted or connected, thus providing a physical standoff barrier to the normal interconnect. Signals originating from the microprocessor 10 are diverted into CFM 12 for parsing. The CFM 12 can comprise memory cells capable of being externally programmed from a trusted hardware source. According to certain aspects of the invention, the memory cells are programmed as a command filter matrix 12 that parses instructions, commands, data fetches and memory destination addresses originating from the microprocessor 10. Based on the image programmed by the trusted hardware source device, the CFM 12 will only allow trusted instructions, commands, data fetches and memory destination addresses to be transported as output signals. This transport filter mechanism is illustrated in FIG. 2.

CFM 12 can be implemented in two independent modules 120 and 122 that interdict microprocessor signals from different code execution partitions of the microprocessor 10. As illustrated, JTAG/Debug and Control module 120 and a HyperTransport Interface module 122 may be employed. The CFM 12 can be configured as a filter matrix to selectively restrict transportation of signals across the filter interface to patterns that match a limited pattern set 24. Accordingly, the filter interface can serve to aggressively defend the microprocessor 10 and its associated system from external malicious attack and control.

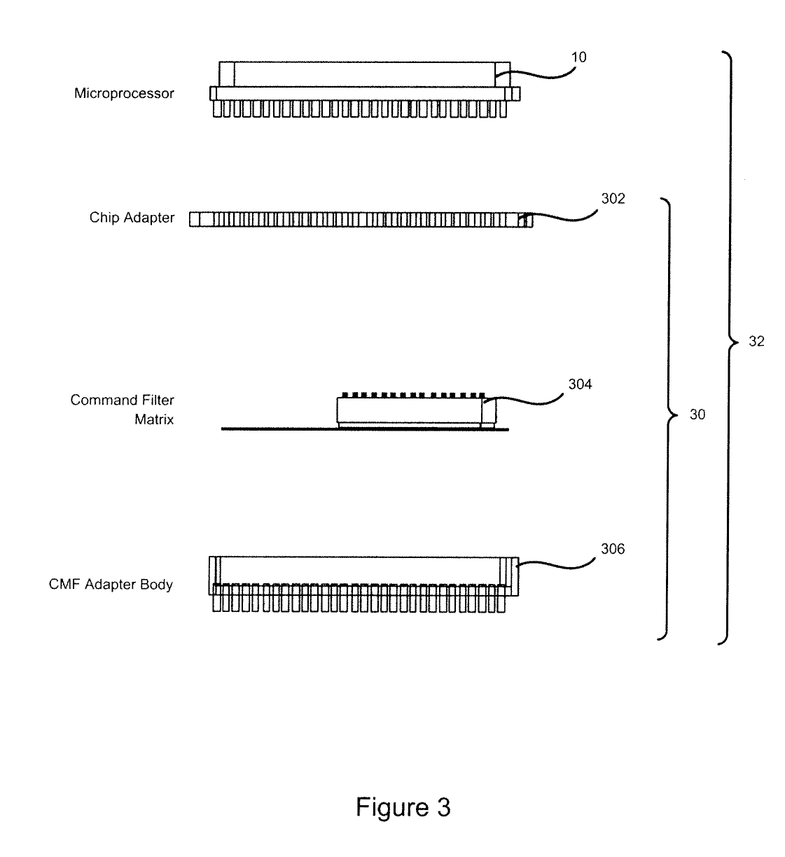

With reference to FIGS. 1 and 3, one example of a system according to certain aspects of the invention is embodied within a physical body constructed to house an assembly comprising a printed wire board (PWB) 16, one or more integrated circuits, such as microprocessor 10, and any necessary electrical interconnect to provide signal, voltage, and control functionality. The one or more integrated circuits can be affixed to the PWB 16 to provide support, signal, and voltage interconnect as well as physical and structural integrity. Integrated circuits may come in many different design formats which accomplish the prescribed or desired functions.

In the example depicted in FIG. 3, a microprocessor adapter assembly 30 is selected to support the target microprocessor 10. Adapter assembly 30 may comprise a chip adapter 302 that performs one or more functions including, for example, routing and mapping signals between microprocessor 10 and CFM 304 or CFM adapter body 306, interception of signals and/or spoofing, replacing or simulating intercepted signals or otherwise missing signals. Adapter assembly 30 can assure secure interconnect of required signals to the one or more integrated circuits. The assembly 30 may be sealed with, for example, a solid curing polymer or epoxy. In at least some embodiments, the microprocessor 10 maybe mounted to the adapter assembly 30 prior to sealing, thereby providing a secured microprocessor 32.

The integrated circuit can be connected to an external trusted source hardware device for configuring, adaptation, test and/or for programming purposes. Connection to a trusted source may be provided through proprietary or standard connections such as JTAG and, in some embodiments, connection may be made through microprocessor interface, typically using a coded sequence. Trusted source programming localizes the universal device 304 to a microprocessor-specific (CFM) device. The CFM 304 may contain external reporting functionality and capability. However, the reporting function cannot typically be accessed by externally addressable memory and the reporting capability is incorporated in the device by ASIC etch.

In certain embodiments, the CFM 304 denies access to any out-of-bounds hardware attempting to connect to unassigned pins, factory test and configuration pins and other non-specified functions on the microprocessor 10. CFM 12 is positioned between the microprocessor 10 and the socket 14 wherein the functional run-time authorized data paths are correctly aligned. The CFM 12 can have a secondary configuration wherein the CFM 12 is manufactured as part of socket 14, and mounted permanently onto the circuit board 16, where it receives the microprocessor 10.

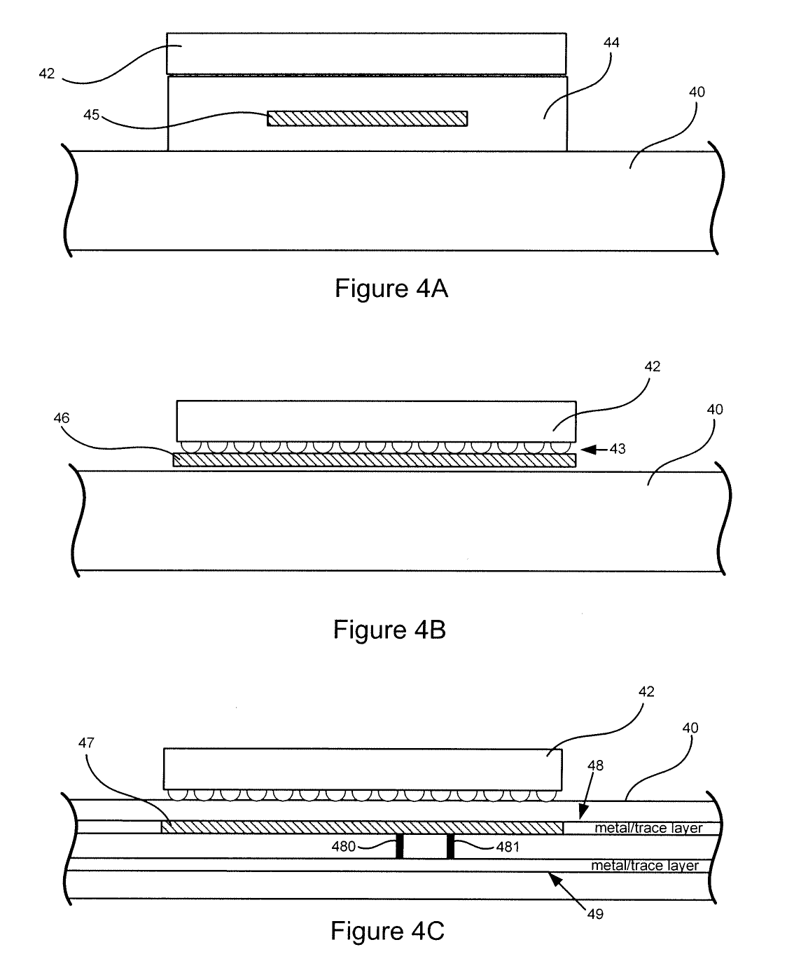

Turning now to FIGS. 4A-4C, additional examples are depicted that show alternative methods for deploying a CFM device. In FIG. 4A, the CFM-protected device 42 is mounted in a socket 44 mounted on a printed circuit board (“PCB”) 40. The CFM device 45 is disposed within the body of socket 44 and intercepts address data, and control signals communicated between device 45 and PCB 40. FIG. 4A is typically used to retrofit systems that use a commercial or proprietary PCB 40. Substitution of a CFM-enabled socket 44 provides CFM protection to integrated circuits, including microprocessors and custom devices alike.

The generation of localization data can be understood using the simple example shown in FIG. 4A. CFM 45 may be configured according to a “standard” profile used for commercially-available processor or controller, whereby pin configurations and command sets are predetermined and consistent between systems using device 42. Specifically, the configuration of FIG. 4A is typically used to connect microprocessors to a motherboard. CFM 45 may be customized and/or localized to account for customizations of signals and command sets. Localization can also be based on data obtained from test systems. For example, subsystems comprising processing device 42 may be subjected to a set of test protocols intended to simulate operational conditions in order to prove software and hardware functionality according to designed specifications. Test results can identify all operations, processes and sequences executed during exhaustive testing and localization information may limit function in “real-world” condition to the set of operations performed and approved during testing. Accordingly, generation of localization data can be largely automated for most applications using processor 42. In addition, exceptions, alerts and other data gathered by CFM 45 can be used to identify conditions and operations that were not simulated or tested, but which are determined to include steps that were not initiated by malware. Reports and data associated with such untested conditions may be used to fix or modify processes or to update localization data.

As depicted in FIG. 4B, a CFM 46 can be adapted for direct connection to a PCB 40. An integrated circuit device 42 can be directly attached to the CFM 46. As shown, device 42 can be a processor, ASIC, controller, memory device, field programmable gate array (“FPGA”) or other device. Device 42 may be bonded or soldered directly to CFM 46, or a portion of CFM 46 using any applicable method for manufacturing circuit boards; as shown, device 42 is provided in a ball grid array (“BGA”) package and CFM 46 may provide solder pads aligned with the BGA solder balls 43. CFM 46 may be bonded or soldered to PCB 40. In some embodiments, CFM 43 occupies a space between connections between device 42 and PCB 40 and some or all of these connections are redirected through CFM 43. For example, CFM 43 may be positioned, much like a spacer, at the center of a BGA that has connections deployed around an outer band of the device 42 such that physical access to CFM 43 is restricted or effectively blocked when device 42 is attached to PCB 40.

FIG. 4C shows one example in which CFM 47 is embedded in PCB 40. In this example, the CFM 47 is embedded within an interconnect layer 48 of PCB 40. Some connections—to the periphery of CFM 47—may be made through depicted copper interconnect layer 48 and other connections may be made using other interconnect layers (e.g. interconnect 49) layer using vias 480 or 481. It will be appreciated that the embodiment of FIG. 4C can physically isolate CFM 47, thereby increasing system effectiveness. However, in some embodiments, CFM 47 can be partially buried in PCB 40. For example, CFM 47 can be provided in a depression, slot, notch or hole in the PCB 40, typically beneath the device 42.

Selection of mounting location of the CFM 47 is typically determined based on the physical attributes of the system, the nature of the device to be protected and whether the system will be maintained at secure facility. For example, it can be preferable to embed a CFM 47 in the PCB 40 (see FIG. 4C) when protecting a processor of a cellular telephone. The cell phone is mobile and subject to physical loss or theft. Moreover space is typically limited in a cell phone and it may be impossible to provide a socket on the PCB 40. In some embodiments, other approaches may be taken. If the system uses flexible circuits, or forms a system on a chip carrier, CFM 45, 46 or 47 may be located physically apart from the device 42 to be protected.

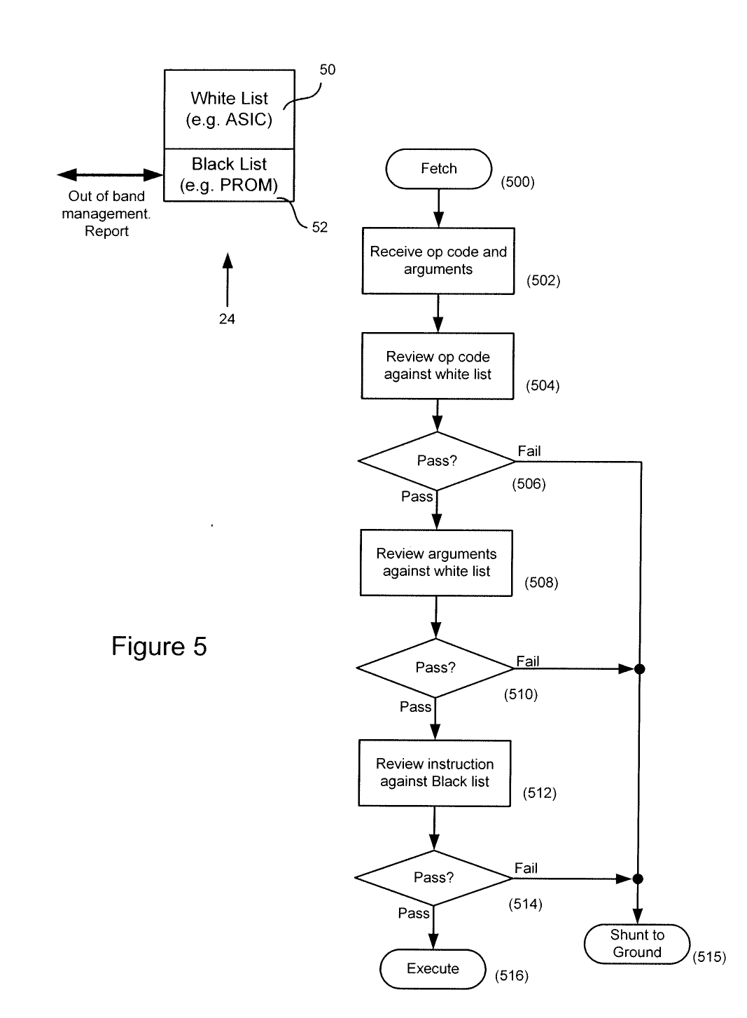

As described herein, CFM 47 may be configured as a filter matrix to selectively restrict transportation of signals across the filter interface to patterns that match a limited pattern set 24 (see FIG. 2). As shown in FIG. 5, pattern set 24 can be organized and/or configured into a plurality of subsets. In some embodiments, subsets can include a list of authorized instructions and arguments, referred to herein as the White List 50 and a list of specifically disallowed instructions, arguments and/or memory addresses, referred to herein as the Black List 52. Disallowed instructions can include certain traps and interrupts, instructions used to access certain devices and/or registers, and so on. FIG. 5 includes a flowchart illustrating one example of operation of a CFM, such as CFM 47 of FIG. 4C. In the example, a fetch issued by a processor of device 42 at step 500 identifies an instruction in memory. The instruction and its arguments are directed to the CFM 47 at step 502. At step 504, the opcode is compared to a list of allowed opcodes in White List 50. If, at step 506, it is determined that the opcode is not authorized, then the opcode and arguments are discarded at step 515 and, typically, substitute opcode and arguments are provided to the processor of device 42. Substitute opcode and arguments can constitute a no-operation (“NOP”) instruction and/or can be branch, jump, TRAP or return from exception instruction that causes the processor to execute an exception handling function. Other instructions can be substituted.

At step 508, the arguments of the authorized opcode are reviewed against the White List 50. Authorization of arguments for an opcode can be determined based on one or more factors including ranges of allowed arguments for the corresponding opcode, address of the instruction causing the opcode to be fetched, state of the system and/or process or sequence. If, at step 510, it is determined that one or more arguments are not authorized, then the arguments and associated opcode are typically discarded at step 515 and substitute opcode and arguments are provided to the processor of device 42. Substitute opcode and arguments can form a no-operation (“NOP”) instruction and/or can be branch, jump, TRAP or return from exception instruction that causes the processor to execute an exception handling function.

At step 512, the opcode and/or arguments of the opcode authorized by the White List 50 are reviewed against the Black List 52. Authorization against Black List can be determined based in a manner similar to the tests performed for the White List 50 authorization. In some embodiments, the Black List may comprise a listing of specific combinations of opcode and arguments. If, at step 514, it is determined that the opcode and arguments are not authorized, then the arguments and associated opcode are typically discarded at step 515 and substitute opcode and arguments are provided to the processor of device 42. Substitute opcode and arguments can form a no-operation (“NOP”) instruction and/or can be branch, jump, TRAP or return from exception instruction that causes the processor to execute an exception handling function. If the opcode and arguments are cleared after evaluation against the Black List 52, then the opcode and arguments are provided to the processor of device 42 for execution.

In certain embodiments, a command filter device such as CFM 47 of FIG. 4C may perform additional functions. In particular, some applications may require code verification at higher levels than at the level of single opcode, sequence of opcodes and/or patterns of opcodes. Accordingly, in certain embodiments the command filter device can identify “state information” that includes information concerning identity of code segments, calling functions, called functions, process threads, operating system context, current processor state, current processor privilege level and whether the processor is in an exception handling (interrupt) mode. Determination of state information can be accomplished by monitoring processor control signals and by matching address and control signal states with state identification information provided by a trusted source. In one example, state identification information can be derived from software and system debuggers.

A command filter that can determine state information has application in systems that require high reliability. For example avionics systems and other in-flight control systems, including weapons and/or threat detection systems, require highly controlled computing systems. In certain embodiments of the invention, command filtering devices can be configured to perform logic checks and/or code comparisons that identify which application process was passing the opcodes to the protected processor 42 and that may be configured to block or forward instructions that are allowed for the application process, process thread and/or current privilege level. Thus, in a highly controlled computing platform, CFM 47 may be provided in an ASIC that maintains opcode level filtering and filtering based on system state information associated with a processor. For maximum security, the ASIC can be embedded in a PCB 40. In certain embodiments, highly reliable systems that employ multiple redundant subsystems, communications pathways can be provided directly between enhanced CFMs 47 on different subsystems such that threats affecting less than all of the subsystems can be more easily identified and confirmed. In some of these embodiments, CFM 47 may include one or more processors that are dedicated to determining and/or inferring system state information.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for a command filter device. Certain embodiments comprise an interconnect configured to intercept signals transmitted between a pair of integrated circuit devices. In certain embodiments, the interconnect comprises a circuit board having a plurality of connecting traces between devices mounted on the board. In certain embodiments, one of the pair of integrated circuit devices comprises a processor. In certain embodiments, the processor can execute instructions transmitted as a sequence in the intercepted signals. Instructions can be microprocessor operation codes and associated arguments, DSP commands, codes for numerical control of industrial equipment such as machine tools, sequencer microcode, for both sequencers that are part of a processor and sequencers built from digital logic. Certain embodiments comprise a command filter matrix coupled to the interconnect. In certain embodiments, the command filter matrix can block transmission of a disallowed instruction to the processor. In certain embodiments, the command filter matrix can selectively forward allowed instructions to the processor.

In certain embodiments, the command filter matrix identifies allowed and disallowed instructions based on a set of associations between a set of instructions and predefined characteristics of the processor. In certain embodiments, the set of associations is provided to the command filter matrix by a trusted source. The trusted source can include a point of manufacture of a system that includes the command filter matrix, a programmer that configures the system or a third party with security clearance that permits access to the device. The command filter matrix may maintain some associations in fixed storage such as PROM and/or in storage that can be updated as needed.

In certain embodiments, each of the set of instructions includes an operation code that specifies an operation to be performed by the processor. In certain embodiments, some of the instructions include an argument that modifies the operation to be performed by the processor. In some processors (e.g. complex instruction set computers), the arguments are transmitted in different signal links or at different times than the operation code. In other processors (e.g. reduced instruction set computers), the arguments are embedded with the opcode. In certain embodiments, the command filter matrix blocks transmission of intercepted signals that conform to a pattern indicative of malware or that otherwise represent a potential threat to operation of the system as intended. In some embodiments, the command filter matrix allows transmission of intercepted signals that conform to a known or recognized pattern. In some embodiments, the patterns are recognized using code comparators, cyclic redundancy codes and other suitable methods.

In certain embodiments, the command filter matrix maintains a set of associations identifies combinations of opcodes and arguments that are allowed. In certain embodiments, the set of associations identifies sequences of instructions that are allowed. In certain embodiments, the set of associations is customized based on the type, and configuration of processor in the one integrated circuit. In certain embodiments, the set of associations identifies one or more instructions that are disallowed. In certain embodiments, transmission an instruction that is identified as both an allowed instruction and a disallowed instruction is blocked. In certain embodiments, the command filter matrix hardware comprises a hardware memory matrix that operates as a code comparator. In certain embodiments, the trusted source configures the command filter matrix using a secure process.

In certain embodiments, the processor comprises a digital signal processor. In certain embodiments, the processor comprises a sequencer. In certain embodiments, the processor comprises a microprocessor. In certain embodiments, the processor comprises one or more of a microcontroller, a digital signal processor, a sequencer and a microsequencer.

Certain embodiments of the invention provide systems and methods for securing a processor or processing system. Certain embodiments comprise providing a command filter matrix between a processor and a source of program instructions. In certain embodiments, the processor is operable to execute one or more of the program instructions. Certain embodiments comprise configuring the command filter matrix with information identifying disallowed combinations of program instructions. Certain embodiments comprise redirecting signal paths between the source of program instructions and the processor to the command filter matrix. In certain embodiments, the command filter matrix is configured to block the signals when the signals correspond to one of the disallowed combinations of program instructions. In certain embodiments, the information identifying disallowed combinations includes lists of operation codes and corresponding arguments. In certain embodiments, the operation codes specify operations to be performed by the processor and certain of the arguments modify the operations to which the operations correspond. In certain embodiments, the command filter matrix blocks signals that correspond to a sequence of instructions identified by the command filter matrix. In certain embodiments, the command filter matrix blocks signals that correspond to a combination of an instruction and an argument identified by the command filter matrix. In certain embodiments, the information identifying disallowed combinations includes address information associated with allowed instructions.

Certain embodiments of the invention provide systems and methods for secured processing systems. Certain embodiments comprise an integrated circuit comprising a processor. Certain embodiments comprise a semiconductor device configured to provide a sequence of instructions to the processor. Certain embodiments comprise a command filter matrix configured to intercept signals transmitted between the processor and the storage device. In certain embodiments, the command filter matrix is further configured to identify allowed and disallowed instructions. In certain embodiments, the command filter matrix is further configured to selectively forward intercepted signals that correspond to allowed instructions. In certain embodiments, the command filter matrix is further configured to block intercepted signals that correspond to disallowed instructions. In certain embodiments, the command filter matrix is configured using a secured process that provides a set of associations to the command filter matrix. In certain embodiments, the set of associations identifies patterns of signals corresponding to the allowed instructions and to the disallowed instructions. In certain embodiments, the command filter matrix is provided in a socket that couples the integrated circuit to a circuit board. In certain embodiments, the command filter matrix is attached to a circuit board and the processor is bonded or soldered to the command filter matrix. In certain embodiments, the command filter matrix is embedded in a circuit board. In certain embodiments, the command filter matrix is provided in an interconnect layer of the circuit board. In certain embodiments, the integrated circuit controls a cellular telephone. In certain embodiments, the integrated circuit is embodied in a numerically controlled machine tool. In certain embodiments, the integrated circuit is embodied in a network communications device. In certain embodiments, the integrated circuit is embodied in an avionics system.

Certain embodiments of the invention provide a secured semiconductor integrated circuit. Some of these embodiments comprise an interconnect configured to intercept signals transmitted between an integrated circuit device and a circuit board. Some of these embodiments comprise a command filter matrix configured to receive the intercepted signals and to selectively transmit the intercepted signals to the circuit board or the integrated circuit device. In some of these embodiments, the command filter matrix is configured by a trusted source. In some of these embodiments, the command filter maintains a set of associations between instructions and data according to characteristics of a target microprocessor device. In some of these embodiments, the command filter maintains a set of associations between instructions, data and characteristics of a target microprocessor device. In some of these embodiments, the command filter matrix transmits only intercepted signals that match entries in the set of associations maintained by the command filter matrix.

In some of these embodiments, the trusted source configures the command filter matrix using a secure process. In some of these embodiments, the command filter matrix hardware comprises a hardware memory matrix. In some of these embodiments, the hardware memory matrix is configured to operate as a code comparator. In some of these embodiments, the selective transmission of the intercepted signals is controlled by the code comparator. In some of these embodiments, the command filter matrix blocks transmission of intercepted signals that conform to a pattern indicative of malware. In some of these embodiments, the command filter matrix is configured to block malware from being executed by the microprocessor. In some of these embodiments, the command filter matrix and the interconnect are embodied in a socket adapted to receive the microprocessor. In some of these embodiments, the command filter matrix and the interconnect are embodied in a component configured for insertion between the microprocessor and a socket adapted to receive the microprocessor.

Certain embodiments of the invention provide a method for controlling semiconductor devices. In some of these embodiments, the method comprises providing a command filter matrix between a microprocessor and a circuit board. In some of these embodiments, the method comprises redirecting signals transmitted between the microprocessor and the circuit board to the command filter matrix. In some of these embodiments, the command filter matrix is configured to receive an address from the microprocessor. In some of these embodiments, the command filter matrix is configured to determine if the address is a valid program-instruction address. In some of these embodiments, the command filter matrix is configured to permit a program instruction to be fetched from the address if the address is a valid program-instruction address. In some of these embodiments, the command filter matrix is configured to redirect the microprocessor to a different address if the address is an invalid program-instruction address. In some of these embodiments, the validity of the program-instruction address is determined based on set of signal patterns maintained by the filter matrix. In some of these embodiments, the program instruction includes a request for data from a data address. In some of these embodiments, the command filter matrix is configured to determine whether the program instruction is one of a group of instructions permitted to request the data from the data address. In some of these embodiments, the command filter matrix is configured to permit the data to be retrieved from the data address when the program instruction is one of the group of instructions permitted to request the data from the data address. In some of these embodiments, the command filter matrix is configured to prevent the data from being retrieved from the data address when the program instruction is not included in the group of instructions permitted to request the data from the data address. In some of these embodiments, responsive to determining if the address is a valid program-instruction address, the command filter matrix is configured to redirect one or more input signals of the microprocessor to corresponding buffers selected based on the validity of the program-instruction address. In some of these embodiments, responsive to determining if the address is a valid program-instruction address, the command filter matrix is configured to redirect one or more output signals of the microprocessor to corresponding buffers selected based on the validity of the program-instruction address.

Certain embodiments of the invention provide devices including semiconductor devices. Some of these embodiments comprise an interconnect configured to intercept signals transmitted from a microprocessor provided in an integrated circuit device to a socket configured to receive the integrated circuit. Some of these embodiments comprise a command filter matrix configured to receive the intercepted signals and to selectively transmit certain of the intercepted signals to the socket. In some of these embodiments, the command filter matrix is configured using a secured configuration process. In some of these embodiments, the secured configuration provides a set of associations to the command filter matrix. In some of these embodiments, the set of associations identifies patterns of signals corresponding to instructions and data associated with the microprocessor. In some of these embodiments, the command filter matrix transmits only intercepted signals that match a pattern of signals identified by the set of associations in the command filter matrix. In some of these embodiments, the command filter matrix is configured by a trusted source. In some of these embodiments, the command filter matrix hardware comprises a code comparator. In some of these embodiments, the code comparator is configured to identify a plurality of valid program instructions from the pattern of signals. In some of these embodiments, the plurality of valid program instructions includes instructions permitted to request data from predetermined data addresses. In some of these embodiments, the plurality of valid program instructions includes instructions located at one or more addresses.

Certain embodiments of the invention provide a semiconductor integrated circuit. Some of these embodiments comprise a command filter matrix arranged so that it may only be programmed by a secure process and arranged to store associations between instructions and data according to requirements resulting from specification of a target microprocessor device. In some of these embodiments, the secure process is arranged to program the command filter matrix from a trusted source. In some of these embodiments, the hardware mechanism comprises a hardware memory matrix programmable as a code comparator. In some of these embodiments, the input and output of signals is controlled by the logical output of the code comparator. In some of these embodiments, hardware and embedded logic functions deny Hardware Exploitation Malware from entering the processing core.

Certain embodiments of the invention provide security process and methods used in semiconductor devices. Some of these embodiments provide an ability to fetch a program instruction from an actual address via a virtual address. Some of these embodiments comprise determining whether the actual address is a valid program-instruction address. Some of these embodiments comprise fetching the program instruction from the actual address if the actual address is a valid program-instruction address; and generating a go/no-go determination. In some of these embodiments, the program instruction includes a request for data from a data address. Some of these embodiments comprise determining whether the program instruction is within a group of instructions allowed to request the data. Some of these embodiments comprise retrieving the data from the data address if the program instruction is within the group of instructions; and generating a go/no-go determination. Some of these embodiments provide an ability to switch or shunt input and output signals to specific input and output buffers according to the logical output of the go/no-go determination.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A command filter comprising:
an interconnect configured to intercept signals transmitted between a pair of integrated circuit devices, wherein one of the pair of integrated circuit devices comprises a processor configured to execute instructions transmitted in the intercepted signals; and
a command filter matrix coupled to the interconnect and operable to block transmission of a disallowed instruction to the processor, and further operable to selectively forward allowed instructions to the processor, wherein the command filter matrix identifies allowed and disallowed instructions based on a set of associations between a set of instructions and predefined characteristics of the processor,
the set of associations is provided to the command filter matrix by a trusted source.

2. The command filter of claim 1, wherein each of the set of instructions includes an operation code that specifies an operation to be performed by the processor.

3. The command filter of claim 2, wherein at least one of the set of instructions includes an argument that modifies the operation to be performed by the processor.

4. A command filter of claim 3, wherein the command filter matrix blocks transmission of intercepted signals that conform to a pattern indicative of malware.

5. The command filter of claim 3, wherein the set of associations identifies combinations of opcodes and arguments that are allowed.

6. The command filter of claim 3, wherein the set of associations identifies sequences of instructions that are allowed.

7. The command filter of claim 3, wherein the set of associations is customized for the one integrated circuit.

8. The command filter of claim 3, wherein the set of associations identifies one or more instructions that are disallowed, and wherein transmission an instruction that is identified as both an allowed instruction and a disallowed instruction is blocked.

9. The command filter of claim 1, wherein the command filter matrix hardware comprises a hardware memory matrix that operates as a code comparator, and wherein the trusted source configures the command filter matrix using a secure process.

10. The command filter of claim 1, wherein the processor comprises a digital signal processor.

11. The command filter of claim 1, wherein the processor comprises a sequencer.

12. The command filter of claim 1, wherein the processor comprises a microprocessor.

13. The command filter of claim 1, wherein the processor comprises one or more of a microcontroller and a digital signal processor.

14. A method, comprising:
providing a command filter matrix between a processor and a source of program instructions, wherein the processor is operable to execute one or more of the program instructions;
configuring the command filter matrix with information identifying disallowed combinations of program instructions; and
redirecting signal paths between the source of program instructions and the processor to the command filter matrix,
wherein the command filter matrix is configured to block the signals when the signals correspond to one of the disallowed combinations of program instructions.

15. The method of claim 14, wherein the information identifying disallowed combinations includes lists of operation codes and corresponding arguments, wherein the operation codes specify operations to be performed by the processor and certain of the arguments modify the operations to which the operations correspond.

16. The method of claim 15, wherein the command filter matrix blocks signals that correspond to a sequence of instructions identified by the command filter matrix.

17. The method of claim 15, wherein the command filter matrix blocks signals that correspond to a combination of an instruction and an argument identified by the command filter matrix.

18. The method of claim 14, wherein the information identifying disallowed combinations includes address information associated with allowed instructions.

19. A secured processing system comprising:
an integrated circuit comprising a processor;
a semiconductor device configured to provide a sequence of instructions to the processor; and
a command filter matrix configured to intercept signals transmitted between the processor and the storage device, wherein the command filter matrix is further configured to:
identify allowed and disallowed instructions;
selectively forward intercepted signals that correspond to allowed instructions; and
block intercepted signals that correspond to disallowed instructions,
wherein the command filter matrix is configured using a secured process that provides a set of associations to the command filter matrix, the set of associations identifying patterns of signals corresponding to the allowed instructions and to the disallowed instructions.

20. The system of claim 20, wherein the command filter matrix is provided in a socket that couples the integrated circuit to a circuit board.

21. The system of claim 20, wherein the command filter matrix is attached to a circuit board and the processor is bonded or soldered to the command filter matrix.

22. The system of claim 20, wherein the command filter matrix is embedded in a circuit board.

23. The system of claim 22, wherein the command filter matrix is provided in an interconnect layer of the circuit board.

24. The system of claim 20, wherein the integrated circuit controls a cellular telephone.

25. The system of claim 20, wherein the integrated circuit is embodied in a numerically controlled machine tool.

26. The system of claim 20, wherein the integrated circuit is embodied in a network communications device.

27. The system of claim 20, wherein the integrated circuit is embodied in an avionics system.
